(19) United States
(12) Patent Application Publication
(10) Pub. No.: US 2026/0300425 A1
(43) Pub. Date: Oct. 1, 2026

(54) LARGE LANGUAGE MODEL (LLM) WITH SOLVER SELECTION FOR OPTIMIZATION PROBLEMS

(71) Applicant: PwC Product Sales LLC, New York, NY (US)

(72) Inventors: Arit Kumar BISHWAS, Fremont, CA (US); Alberto Massoco TIZIANEL, Porto (PT); Arish PITCHAI, Madurai (IN)

(73) Assignee: PwC Product Sales LLC, New York, NY (US)

(21) Appl. No.: 19/631,780

(22) Filed: Mar. 27, 2026

Related U.S. Application Data
(60) Provisional application No. 63/779,474, filed on Mar. 28, 2025.

(51) Int. Cl. G06F 17/11; G06N 20/00

(52) U.S. Cl. CPC G06F 17/11; G06N 20/00

(57) ABSTRACT

A method for solving an optimization problem using one or more LLM agents includes: receiving an input prompt comprising a natural language problem statement specifying one or more characteristics of the optimization problem; processing the input prompt using one or more LLM agents to generate a query; executing the query upon a vector database to identify an optimization problem solver of a plurality of optimization problem solvers; generating computer executable code specifying one or more characteristics of the optimization problem using the one or more LLM agents, wherein the computer executable code is generated based on the identified optimization problem solver; inputting the computer executable code into the identified solver; and outputting a solution to the optimization problem.

### CROSS-REFERENCE TO RELATED APPLICATIONS

This application claims the benefit of U.S. Provisional Application No. 63/779,474, filed Mar. 28, 2025, the entire contents of which are incorporated herein by reference.

### FIELD

This disclosure relates generally to large language model (LLM) agents and more specifically to using multiple specialized LLM agents to solve optimization problems.

### BACKGROUND

Optimization problems are fundamental challenges encountered across diverse fields, including economics, engineering, and computer science. Such problems involve identifying optimal solutions that either maximize or minimize a specific objective function. Real-world applications of optimization are extensive and impactful. Solutions to such problems can be leveraged to significantly reduce energy consumption in smart grids, streamline and enhance supply chain efficiency, or maximize profitability in algorithmic trading operations. Despite their potential benefits, the process of optimization modeling—translating a business problem into a mathematical optimization problem—demands specialized expertise. For example, expertise is required to select and implement appropriate optimization problem solvers. Conventional systems often demand deep knowledge in both business domains and mathematical optimization techniques, creating a substantial barrier for many organizations.

### SUMMARY

Disclosed herein are systems, methods, and non-transitory computer-readable storage media for solving optimization problems using one or more LLM agents or other generative artificial-intelligence-based agents (referred to herein, for illustrative purposes, as “LLM agents”). An exemplary system may process an input received from a user to determine characteristics of an optimization problem specified in the input. The system may compare those characteristics to data in a knowledge base, wherein the data represents information (e.g., applicable industries, optimization problem types the solver can solve, etc.) about different optimization problem solvers. The system may thus identify an optimal solver for the problem specified in the input. The system may prompt one or more LLM agents using a prompt generated based on data associated with the selected optimization problem solver to teach the one or more LLM agents to generate code executable by the selected solver. The code generated using the one or more LLM agents may be input into the optimization problem solver to generate a solution to the optimization problem.

In some embodiments, any one or more of the characteristics of any one or more of the systems, methods, and/or computer-readable storage mediums recited above may be combined, in whole or in part, with one another and/or with any other features or characteristics described elsewhere herein.

### BRIEF DESCRIPTION OF THE FIGURES

A better understanding of the features and advantages of the present disclosure will be obtained by reference to the following detailed description that sets forth illustrative embodiments, in which the principles of the disclosure are utilized, and the accompanying drawings of which:

FIG. 1 illustrates an exemplary system for solving optimization problems using one or more LLM agents, according to some examples.

FIG. 2 illustrates an exemplary method for creating a knowledge base that may be used according to the systems and methods herein to solve optimization problems, according to some examples.

FIG. 3 illustrates an exemplary method for solving optimization problems using one or more LLM agents, according to some examples.

FIG. 4 illustrates an exemplary method for solving optimization problems using one or more LLM agents, according to some examples.

FIG. 5 illustrates an exemplary computing device, according to some examples.

FIG. 6 illustrates an exemplary method for solving optimization problems using one or more LLM agents, according to some examples.

FIG. 7 illustrates an exemplary method for solving an optimization problem using one or more LLM agents, according to some examples.

### DETAILED DESCRIPTION

Disclosed herein are systems, methods, and non-transitory computer readable storage media for solving optimization problems using one or more LLM agents or other generative artificial-intelligence-based agents (referred to herein, for illustrative purposes, as “LLM agents”). An LLM agent, as used herein, may refer to an AI-powered software module. An LLM agent may include or have access to one or more large language models (LLMs), other machine learning model(s), including other generative AI models, memory, and/or other tools such as application programming interfaces (APIs), data visualization software, etc. In some examples, a plurality of LLM agents are used to transform a natural language user input into computer executable code for solving an optimization problem. The plurality of LLM agents may form a processing pipeline in which each of the plurality of LLM agents may be prompted by the system to perform a particular task contributing to the transformation of the user input into computer executable code.

The systems and methods disclosed herein may leverage a knowledge base that includes information associated with a plurality of different optimization problem solvers and characteristics of optimization problems those solvers are suited for. The system may compare characteristics of an optimization problem specified in a user input to the information associated with different solvers in the knowledge base. The system can identify the optimal solver for a given optimization problem based on the comparison. For instance, the characteristics of the optimization problem specified in the user input may be compared to characteristics of optimization problems that one or more solvers are suited for, and a solver may be selected based on a similarity metric used in the comparison (e.g., cosine similarity, Euclidean distance, etc.). In some examples, characteristics of the optimization problem specified in the user input may be encoded into an embedding. The embedding may be used to query a database (e.g., a vector database) in which embeddings associated respective optimization problem solvers are stored. The system may identify an embedding stored in the database that is most similar to the embedding associated with the input optimization problem and may select the optimization problem solver associated with the embedding stored in the database to solve the optimization problem.

As noted above, the knowledge base may include a vector database that the system can leverage, for instance, using retrieval-augmented generation (RAG), to identify an appropriate (e.g., optimal) solver for a given optimization problem. The system may also retrieve information from the knowledge base that can be used to teach LLM agents to generate code for a particular solver. The system may retrieve information associated with the selected solver from the knowledge base and incorporate the information into a prompt for one or more LLM agents, for instance, to teach the one or more LLM agents to generate computer executable code for solving an optimization problem with the selected solver. The system may also generate synthetic information that can be incorporated into a prompt for one or more LLM agents. In some examples, the synthetic information may be generated using an LLM based on the selected solver and/or information stored in association with the selected solver in the knowledge base.

In the following description of the various embodiments, it is to be understood that the singular forms “a,” “an,” and “the” used in the following description are intended to include the plural forms as well, unless the context clearly indicates otherwise. It is also to be understood that the term “and/or” as used herein refers to and encompasses any and all possible combinations of one or more of the associated listed items. It is further to be understood that the terms “includes, “including,” “comprises,” and/or “comprising,” when used herein, specify the presence of stated features, integers, steps, operations, elements, components, and/or units but do not preclude the presence or addition of one or more other features, integers, steps, operations, elements, components, units, and/or groups thereof.

Certain aspects of the present disclosure include process steps and instructions described herein in the form of an algorithm. It should be noted that the process steps and instructions of the present disclosure could be embodied in software, firmware, or hardware and, when embodied in software, could be downloaded to reside on and be operated from different platforms used by a variety of operating systems. Unless specifically stated otherwise as apparent from the following discussion, it is appreciated that, throughout the description, discussions utilizing terms such as “processing,” “computing,” “calculating,” “determining,” “displaying,” “generating” or the like, refer to the action and processes of a computer system, or similar electronic computing device, that manipulates and transforms data represented as physical (electronic) quantities within the computer system memories or registers or other such information storage, transmission, or display devices.

The present disclosure in some embodiments also relates to a device for performing the operations herein. This device may be specially constructed for the required purposes, or it may comprise a general-purpose computer selectively activated or reconfigured by a computer program stored in the computer. Such a computer program may be stored in a non-transitory, computer readable storage medium, such as, but not limited to, any type of disk, including floppy disks, USB flash drives, external hard drives, optical disks, CD-ROMs, magnetic-optical disks, read-only memories (ROMs), random access memories (RAMs), EPROMs, EEPROMs, magnetic or optical cards, application specific integrated circuits (ASICs), or any type of media suitable for storing electronic instructions, and each connected to a computer system bus. Furthermore, the computing systems referred to in the specification may include a single processor or may be architectures employing multiple processor designs, such as for performing different functions or for increased computing capability. Suitable processors include central processing units (CPUs), graphical processing units (GPUs), field programmable gate arrays (FPGAs), and ASICs.

The methods, devices, and systems described herein are not inherently related to any particular computer or other apparatus. Various general-purpose systems may also be used with programs in accordance with the teachings herein, or it may prove convenient to construct a more specialized apparatus to perform the required method steps. The structure for a variety of these systems will appear from the description below. In addition, the present invention is not described with reference to any particular programming language. It will be appreciated that a variety of programming languages may be used to implement the teachings of the present disclosure as described herein.

### Exemplary System for Solving Optimization Problems

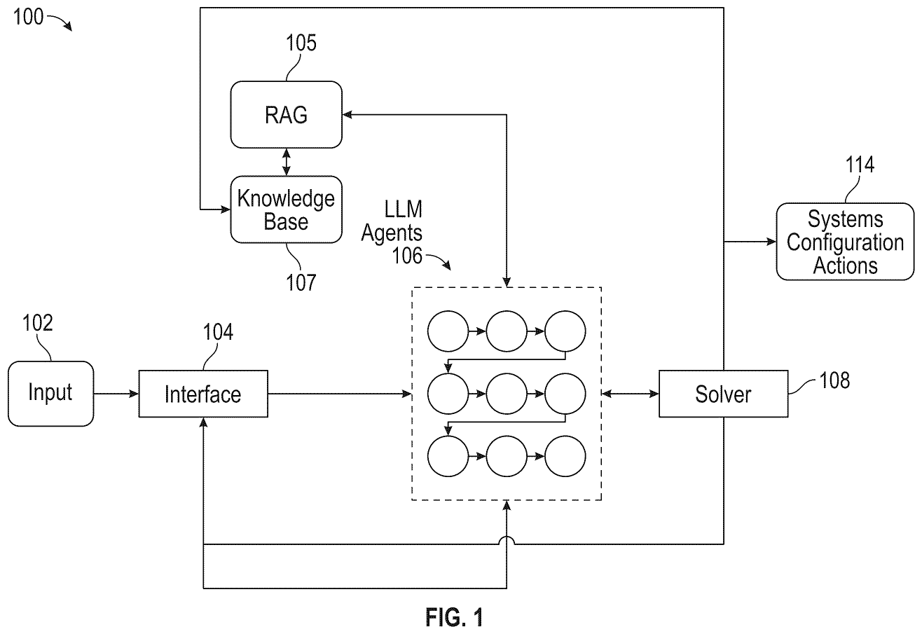

FIG. 1 illustrates an exemplary block diagram representing a computing system 100 for solving optimization problems using a plurality of large language model (LLM) agents 106 and a solver 108. Computing system 100 is configured to receive an input 102. The input 102 may be received by system 100 via an interactive user interface 104. The interactive user interface 104 may include a graphical user interface configured to receive user inputs 102. An input 102 may specify one or more characteristics of an optimization problem. The inputs 102 may include, but are not limited to, a natural language description of an optimization problem, an audio description of an optimization problem, one or more datasets associated with an optimization problem, and/or other data (e.g., images, video, . csv files, etc.). The user interface 104 may also be configured to enable a user to select a type of solver for the optimization problem (e.g., a classical solver or a quantum solver).

System 100 may be configured to automatically select an appropriate (e.g., optimal) optimization problem solver 108 for a given input 102. In some examples, system 100 may include a retrieval-augmented generation (RAG) data processing module 105 that enables aspects of system 100 to query a knowledge base 107 storing information associated with different types of optimization problem solvers to identify and select the optimization problem solver 108. One or more LLM agents 106 may process an input 102 to generate a query that can be executed on the knowledge base 107 (e.g., via RAG data processing module 105). In some examples, the knowledge base 107 includes a vector database.

To generate the query, the one or more LLM agents 106 may process input 102 to determine one or more characteristics associated with an optimization problem specified in input 102. For instance, the one or more LLM agents 106 may process input 102 to determine a business goal, an optimization objective, parameters, decision variables, and/or constraints. The system may generate the query using the characteristics associated with the optimization problem determined from the input 102, optionally including the optimization objective, parameters, decision variables, constraints, and/or algorithmic representation of the optimization problem. The query may include a problem description, indication(s) of one or more parameters, indication(s) of one or more variables, indication(s) of one or more constraints, indication(s) of business context, indication(s) of mathematical context, indication(s) of an optimization objective, and/or other information associated with the optimization problem specified in input 102.

In some examples, processing the input 102 using the one or more LLM agents 106 to generate the query may include executing one or more feature extraction processes to extract the business goal and one or more parameters from input 102. One or more LLM agents 106 may compare the business goal and one or more parameters to information included in a dataset forming part of input 102 to ensure the output of the one or more LLM agents aligns with the input data, and the one or more LLM agents may adjust the parameters and/or business goal if discrepancies are detected. One or more LLM agents 106 may determine (e.g., extract or generate) an optimization objective, context, one or more decision variables, and/or one or more constraints associated with the optimization problem using the extracted parameters. The context may include a summary of the input 102 generated using an LLM. One or more LLM agents 106 may also formulate an algorithmic representation of the optimization problem specified in input 102 using the objective, parameters, decision variables, and/or constraints.

System 100 may execute the generated query on a knowledge base 107 to identify and select an optimization problem solver suited for the given optimization problem specified in input 102. Knowledge base 107 may include information associated with linear programming solvers, mixed integer linear programming solvers, convex optimization problem solvers, non-convex optimization problem solvers, constrained optimization problem solvers, stochastic optimization problem solvers, discrete optimization problem solvers, continuous optimization problem solvers, non-linear optimization problem solvers, and/or any other type of optimization problem solver(s). The query may include information describing the optimization problem specified in input 102 that can be compared to the information associated with different optimization problem solvers stored in knowledge base 107. Based on the comparison, system 100 may identify and select the optimal optimization problem solver for the optimization problem specified in input 102. System 100 may retrieve information associated with the selected optimization problem solver from knowledge base 107 and use the retrieved information to prompt one or more LLM agents 106 to generate computer executable code suitable for the selected optimization problem solver.

In some examples, the query may be executed on a vector database of knowledge base 107 using a retrieval-augmented generation (RAG) data processing module 105. The query may be encoded into an embedding vector (e.g., using an embedding model of RAG data processing module 105). The embedding vector may capture rich semantic meaning associated with the query in a lower-dimensional vector. The embedding vector representing the query may be compared to embeddings representing information associated with different optimization problem solvers stored in vector database 107, for instance, based on cosine similarity, Euclidean distance, etc. In some examples, each of a plurality of embeddings stored in the vector database may represent a respective one or more of the plurality of optimization problem solvers. For instance, a first embedding may represent information associated with a first optimization problem solver of the plurality of optimization problem solvers, a second embedding may represent information associated with a second optimization problem solver of the plurality of optimization problem solvers, etc. The embeddings may be generated using an embedding model (e.g., a machine learning model) and may capture rich semantic information associated with one or more or the plurality of optimization problem solvers. For instance, the embeddings representing the respective solvers may indicate an applicable industry, a solver type (e.g., linear vs. non-linear, quantum vs. classical, etc.), an application type, applicable optimization techniques, suitable objective functions for the given solver, example constraints of optimization problems suitable for the given solver, and example mathematical formulations of optimization problems suitable for the given solver. At least some of the information captured in the embeddings representing the respective solvers may be synthetic information generated using a generative AI model (e.g., using an LLM). Aspects of exemplary information that may be included in the embeddings stored in the vector database are shown in Appendix A, which is described in further detail below.

Thus, the embeddings stored in a vector database of knowledge base 107 may include information that can be compared to information included in a query generated based on the input 102. System 100 may identify a most similar embedding to the embedding representing the query and select the solver associated with the most similar embedding. The system may retrieve information associated with the solver (e.g., from the vector database or a storage location in knowledge base 107 identified by the vector database) represented by the selected embedding and use it to prompt one or more LLM agents 106 to generate computer executable code suitable for the selected optimization problem solver. In some examples, system 100 may additionally employ hypothetical document embedding (HyDE) techniques to enrich the retrieved information associated with respective solvers. Synthetic data may be generated using a generative AI model (e.g., an LLM) and may be used along with data retrieved from knowledge base 107 to prompt one or more LLM agents 106 to generate computer executable code for solving an optimization problem specified by input 102 using a particular optimization problem solver. Thus, system 100 enables autonomous and automated optimization of computer executable code tailored to particular optimization problem solvers based on a type of optimization problem, business context associated with the optimization problem, mathematical context associated with the optimization problem, and/or other factors, as discussed above.

The computer executable code generated using the plurality of LLM agents 106 may be input into the selected solver 108 to generate a solution to the optimization problem. The solver 108 may generate and output a solution to the problem. The selected solver 108 may be or include a classical solver or quantum solver configured to solve optimization problems. The solver may include a D-Wave Leap Hybrid Solver, or other quantum solver. The solver may be a linear programming solver, mixed integer linear programming solver, convex optimization problem solver, non-convex optimization problem solver, constrained optimization problem solver, stochastic optimization problem solver, discrete optimization problem solver, continuous optimization problem solver, non-linear optimization problem solver, and/or any other type of optimization problem solver(s). The solution may correspond to a configuration with the lowest energy of a plurality of configurations. The output may include the energy and one or more corresponding spin configurations. The solution may be provided to a user via interface 104 of computing system 100. In some examples, the solution is input into an one or more of the LLM agents 106 configured to generate a report based on the solution. The report may be a natural language explanation of the solution to the optimization problem specified by input 102 and may be displayed to a user via the interface 104. The report may include recommended action items to be executed based on the solution.

In some examples, information associated with the optimization problems solved using system 100 (and/or any of the systems and methods disclosed herein) may be stored in the knowledge base 107 such that the system can iteratively/continuously improve in its ability to formulate, code, select solvers for, and solve optimization problems. In some examples, information associated with the optimization problems solved using system 100 may be used to update the knowledge base 107 such that the information stored in association with the solver(s) is up-to-date, enabling the system to select the optimal solver to solve a given optimization problem(s). The information used to update the knowledge base 107, including the vector database, may include user inputs, outputs of one or more LLM agents (e.g., optimization objectives, parameters, constraints, algorithmic formulations, code, etc.), solutions to the optimization problems, etc. In some examples, the system may update embeddings stored in a vector database and/or add new embeddings to the vector database associated with a respective optimization problem solver.

In some examples, the selected solver 108 may be part of system 100 and in other examples the selected solver 108 may be external to system 100. In some examples, the solver 108 may be hosted on the same computing device as the LLM agents 106. In some examples, the LLM agents 106 and/or the solver 108 may reside on the cloud. In some examples, the plurality of LLM agents 106 may be configured to operate locally at one or more client devices (e.g., a desktop computer, mobile phone, laptop, etc.) and/or at one or more remote servers (e.g., on the cloud). The plurality of LLM agents 106 may utilize a combination of computing resources from one or more client devices and one or more remote servers. Computer executable code generated using the plurality of LLM agents may be transmitted over a network from a first computing device to a second computing device hosting the selected solver 108 using any electronic communications protocol. In some examples, the plurality of LLM agents 106 and the solver 108 may run at the same server or a different server.

System 100 may include any number of LLM agents 106, including as few as one LLM agent 106. In examples where more than on LLM agent 106 is used, the plurality of LLM agents 106 may be arranged in series and/or in parallel with one another in order to apply a plurality of sub-transformations (e.g., in series with one another) to transform the input 102 into computer executable code. In some examples, only a subset of the LLM agents are invoked to transform the input 102 into computer executable code. In some examples, LLM agents may be configured to perform multiple tasks. For instance, an LLM agent may be configured to both generate an algorithmic formulation of a prompt and generate code based on the mathematical formulation. One or more of the LLM agents may be configured to perform their respective tasks using zero-shot prompting, one or more of the LLM agents may be configured to perform their respective tasks using one-shot prompting, and/or or more of the LLM agents may be configured to perform their respective tasks using few-shot prompting.

Computing system 100, or a user thereof, may execute various systems configuration actions 114 based on the solution to the optimization problem. For example, the solution to the optimization problem may include a system configuration that maximizes or minimizes a value based on an objective of the optimization problem. The value may include, for instance, monetary cost, energy resources, material consumption, computing resource utilization, time, distance, or any other value. In some examples, system 100 automatically provisions a computational resource based on the solution to the optimization problem, automatically establishes a network connection based on the solution to the optimization problem, and/or automatically sends a control signal to an electromechanical device based on the solution to the optimization problem.

System 100 may be used to solve any type of optimization problem, for instance, including combinatorial optimization problems (e.g., traveling salesman problem and/or other “NP-hard” optimization problems), convex optimization problems, non-convex optimization problems, constrained optimization problems, stochastic optimization problems, discrete optimization problems, continuous optimization problems, linear optimization problems, non-linear optimization problems, and/or any other type of optimization problem(s).

### Exemplary Method for Creating a Vector Database

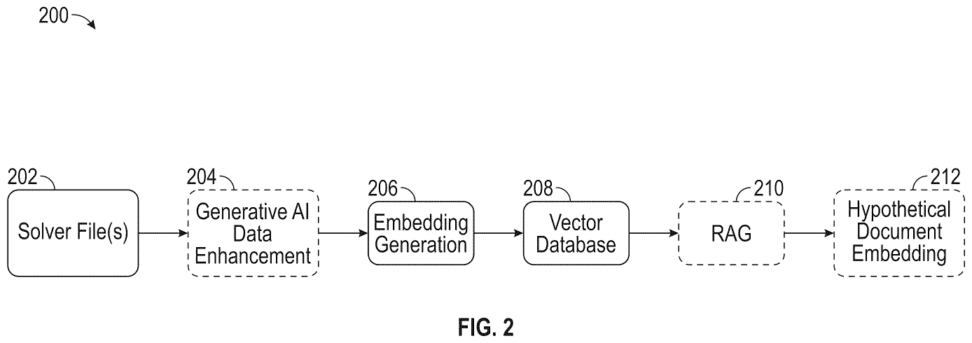

FIG. 2 illustrates aspects of an exemplary method 200 for constructing a vector database that can be used for retrieval-augmented generation to optimize LLM agent generative outputs for particular optimization problem solvers (e.g., via few-shot prompting). Method 200 is performed, for example, using one or more electronic devices implementing a software platform. In some examples, method 200 is performed using a client-server system, and the steps of process 200 are divided up in any manner between the server and one or more client devices. In other examples, method 200 is performed using only a client device or only multiple client devices. In method 200, some steps are, optionally, combined, the order of some steps is, optionally, changed, and some steps are, optionally, omitted. In some examples, additional steps may be performed in combination with the method 200. Accordingly, the operations as illustrated (and described in greater detail below) are exemplary by nature and, as such, should not be viewed as limiting.

At block 202, an exemplary system (e.g., one or more electronic devices) may ingest data associated with a plurality of optimization solvers. The system may ingest data associated with classical optimization problem solvers and/or quantum optimization problem solvers (e.g., quantum annealers). For instance, the system may ingest information associated with linear programming solvers, mixed integer linear programming solvers, convex optimization problem solvers, non-convex optimization problem solvers, constrained optimization problem solvers, stochastic optimization problem solvers, discrete optimization problem solvers, continuous optimization problem solvers, non-linear optimization problem solvers, and/or any other type of optimization problem(s). In some examples, the system may ingest a plurality of files, each file including information associated with at least one optimization problems solver. One or more of the plurality of files may include an indication of, a respective solver, an applicable industry (e.g., manufacturing, healthcare, etc., examples of which are shown in Appendix A), a solver type (e.g., linear vs. non-linear, quantum vs. classical, etc., examples of which are shown in Appendix A), an application type (e.g., including the application types shown in Appendix A, such as vehicle routing, portfolio optimization, power generation scheduling), applicable optimization techniques (e.g., MILP, Constraint Programming, etc., other examples of which are included in Appendix A), suitable objective functions for the solver (e.g., minimize material handling cost, minimize generation cost for power grid optimization applications, etc., other examples of which are included in Appendix A), example constraints of optimization problems suitable for the solver (e.g., resource availability production planning for manufacturing, etc., other examples of which are included in Appendix A), and example mathematical formulations of optimization problems suitable for the solver (e.g., as shown in Appendix A), and/or other information associated with the solver.

At block 204, the exemplary system may enhance the data associated with the plurality of optimization solvers. The exemplary system may associate indications of optimization problems that the respective solvers are suited for solving with each of the plurality of optimization problem solvers included in the ingested data. For instance, the exemplary system may associate business context (e.g., business problems), mathematical context (e.g., associated with particular types of optimization problems), computer executable code, programming libraries (e.g., python libraries), and/or other information regarding relevant (e.g., solvable using a respective solver) example optimization problems with each of the plurality of optimization solvers. In some examples, the system may enhance the data associated with the plurality of optimization solvers with synthetic data generated using a generative AI model (e.g., LLM, GAN, etc.). The synthetic data may include, but is not limited to, synthetic case information, synthetic mathematical context, synthetic business context, synthetic code, and synthetic programming modules/libraries. The synthetic data may provide a more comprehensive representation of the type of optimization problem a given optimization problem solver is suited for solving.

At block 206, the exemplary system may generate a plurality of embeddings. Each of the plurality of embeddings may represent information associated with a respective one or more of the plurality of optimization problem solvers. For instance, a first embedding may be generated that represents information associated with a first optimization problem solver of the plurality of optimization problem solvers, a second embedding may be generated that represents information associated with a second optimization problem solver of the plurality of optimization problem solvers, etc. In some examples, a plurality of embeddings may be generated for each solver, each embeddings representing different data associated with the solver. The embeddings may be generated using an embedding model (e.g., a machine learning model) and may capture rich semantic information associated with one or more or the plurality of optimization problem solvers. In some examples, information associated with a respective one or more solvers is included in a json file, and the system uses an embedding model to convert the json file into a respective embedding. The following keys may be used to create embedded content for incorporation into the vector database: industry, application, optimization techniques, objective function, constraints. The above-described keys may also be stored as metadata associated with the respective embeddings.

At block 208, the system may construct a vector database using the plurality of embeddings. The system may index the generated embeddings within the vector database using flat indexing, graph indexing, inverted indexing, or another indexing method. The vector database may enable the system to identify one or more embeddings within the vector database that are similar to an embedding representing a user-defined optimization problem, for instance, based on cosine similarity, Euclidean distance, etc. Thus, the exemplary system may create a searchable vector database in which embedding representations of information (e.g., solver types, business context, mathematical context) associated with a plurality of different optimization problem solvers can be identified by the system based on comparisons to a user-defined optimization problem.

At block 210, the system may leverage the vector database 208 for retrieval-augmented generation. For instance, when a user utilizes the system disclosed herein to solve optimization problems, the system may compare information associated with the optimization problem described in a user input to information associated with optimization problem solvers stored in the vector database to identify an optimal solver for the given problem. The system can then generate prompts (e.g., few-shot prompting) using information retrieved from the vector database to teach LLM agents how to construct computer executable code for solving the optimization problem described by the user for the identified solver.

At block 212, the system may leverage hypothetical document embedding (HyDE) to provide additional information, alongside information retrieved from the vector database, to teach LLM agents how to construct computer executable code for solving the optimization problem described by the user for the identified solver. Hypothetical document embedding (HyDE) techniques may be used to dynamically enrich the retrieved information associated with respective solvers. Synthetic data may be generated using a generative AI model (e.g., an LLM) and may be used along with data retrieved from vector database to prompt one or more LLM agents to generate computer executable code for solving an optimization problem specified by input using a particular optimization problem solver (e.g., as described with reference to system 100).

### Exemplary Method for Solving Optimization Problems

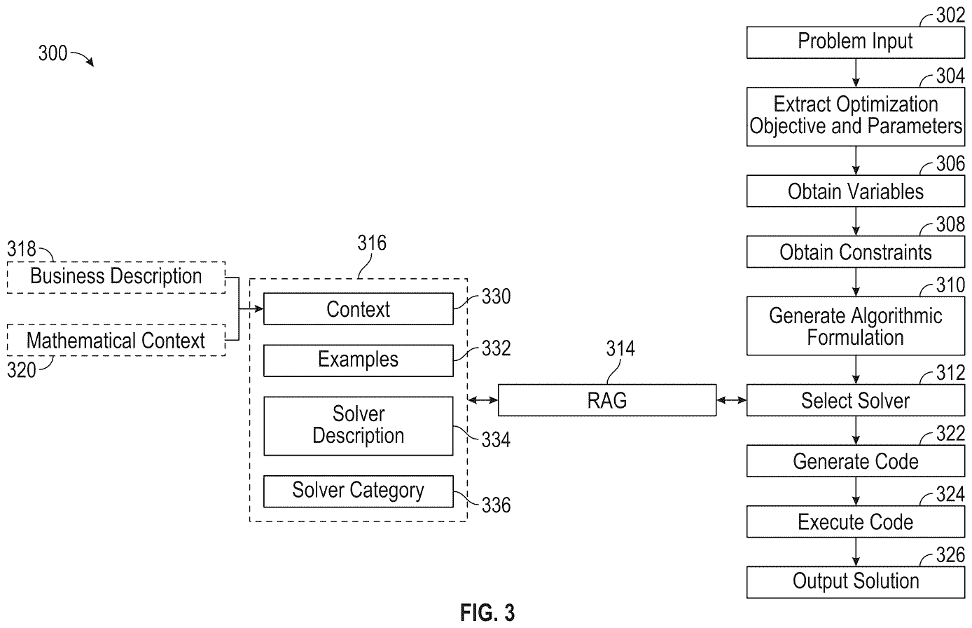

FIG. 3 illustrates an exemplary method 300 for solving an optimization problem using one or more LLM agents. Method 300 may be performed using any or all of the aspects described above with reference to FIGS. 1-2. Method 300 may include automatically selecting an optimal optimization problem solver for a respective problem and prompting one or more LLM agents with examples associated with the selected solver to teach the one or more LLM agents how to interact with (e.g., generate code for) the selected solver. In some examples, method 300 is performed using a single LLM agent or multiple LLM agents. In some examples, method 300 may be performed using a plurality of LLM agents operating in series with one another. In some examples, method 300 may be performed using a plurality of LLM agents where some LLM agents operate in series with one another and others operate in parallel with one another.

Method 300 is performed, for example, using one or more electronic devices implementing a software platform. In some examples, method 300 is performed using a client-server system, and the steps of process 300 are divided up in any manner between the server and one or more client devices. In other examples, method 300 is performed using only a client device or only multiple client devices. In method 300, some steps are, optionally, combined, the order of some steps is, optionally, changed, and some steps are, optionally, omitted. In some examples, additional steps may be performed in combination with the method 300. Accordingly, the operations as illustrated (and described in greater detail below) are exemplary by nature and, as such, should not be viewed as limiting.

At block 302, an exemplary system (e.g., one or more electronic devices) may receive an input problem statement specifying one or more characteristics of an optimization problem. The input may include a natural language problem statement specifying one or more characteristics of the optimization problem. The input may also include a dataset associated with the optimization problem. The input may be received via an interactive user interface. The input may include audio data or other media data. The dataset associated with the optimization problem may include structured data, etc. (e.g., images, video, . csv files, etc.). The dataset may include, for instance, variable symbols, parameter symbols, etc., which may enable the system to more accurately transform the input into computer executable code for solving the optimization problem. The input may include a request that a certain value be minimize or maximized (e.g., “find the shortest route”). The input may specify one or more characteristics of an optimization problem that can be solved using a quantum annealer or classical annealer.

At block 304, the exemplary system may determine one or more objectives (e.g., optimization objectives) associated with the input problem statement and one or more parameters associated with the problem statement. The system may process the problem statement using one or more LLM agents to extract the optimization objective and/or the one or more parameters. The one or more LLM agents may determine the optimization objective based at least in part on the one or more parameters and the input received at block 302. For instance, an exemplary prompt may request an optimized assignment of flights to airport gates to minimize the distance passengers need to travel to get to their gate. In such an example, the objective may be, for instance, “minimize the total distance that passengers need to travel from the gate to their respective flights.”

The one or more LLM agents may generate and assign symbols to the extracted parameters and may generate a definition for each parameter. The definition may include an explanation of the symbol assigned to a parameter. Continuing the example described above, a symbol “NumberofGates” may represent one of the extracted parameters. The definition may be “number of gates at the airport.” In some examples, the one or more LLM agents may determine a dimension (e.g., shape) of each of the extracted parameters. In some examples, the one or more LLM agents may replace each of the parameters in the input received at block 302 with the corresponding symbol that was generated using the one or more LLM agents. In some examples, the symbols and/or definition assigned to one or more parameters may be determined with reference to a dataset included in the input received at block 302.

The one or more LLM agents may also determine an optimization problem type based on the input received at block 302. For instance, the one or more LLM agents may determine the input corresponds to a combinatorial optimization problem (e.g., traveling salesman problem and/or other “NP-hard” optimization problems), a convex optimization problem, a non-convex optimization problem, a constrained optimization problem, a stochastic optimization problem, a discrete optimization problem, a continuous optimization problem, a linear optimization problem, a non-linear optimization problem, and/or any other type of optimization problem(s).

At block 306, the exemplary system may determine one or more decision variables for the optimization problem. The one or more decision variables may be determined based at least in part on the input received at block 302, the one or more parameters, and/or the optimization objective. The one or more decision variables may be determined using the one or more LLM agents. A value assigned to the one or more decision variables may later be solved for using a solver, as described in further detail below. Continuing the example of optimizing the assignment of flights to gates at an airport noted above, the one or more decision variables may include, for instance, a binary variable indicating whether a flight i is assigned to a gate j.

At block 308, the exemplary system may determine one or more constraints for the optimization problem. The one or more constraints may be determined using one or more LLM agents using the input received at block 302 and/or any of the above-described outputs of the one or more LLM agents (e.g., the parameters, optimization objective, and/or decision variables, etc.). Continuing the example of optimizing the assignment of flights to gates at an airport to minimize the distance passengers need to travel to get to their gate, the constraints may include, for instance, “each flight can only be assigned to one gate,” “each gate can only be assigned to one flight,” etc. The one or more LLM agents may also determine whether any additional decision variables are needed based on the one or more constraints, and if so, may generate one or more additional decision variables to be solved for.

At block 310, the system may generate an algorithmic formulation of the optimization problem. The system may generate an algorithmic formulation of the optimization problem using, for instance, the input received at block 302, the one or more parameters, decision variables, constraints, and/or optimization objective, etc., generated using the one or more LLM agents. The system may generate the algorithmic formulation of the optimization problem using one or more LLM agents. In some examples, different LLM agents may generate different portions of the algorithmic formulation. For instance, a first LLM agent may generate an algorithmic formulation of the optimization objective and a second LLM agent may generate an algorithmic formulation of the one or more constraints. In some examples, the algorithmic formulation of the optimization problem (e.g., including the is generated using algorithmic formulation of the optimization objective and the algorithmic representation of the constraints) is generated using one LLM agent.

At block 312, the system may select a solver for solving the optimization problem. The system may generate a query using the input received at block 302, the one or more parameters, the one or more decision variables, the optimization objective, the one or more constraints, and/or the algorithmic formulation of the optimization problem. The query may be encoded into an embedding vector (e.g., using an embedding model). The embedding vector may include an indication of any one or more of the input received at block 302, the one or more parameters, the one or more decision variables, the optimization objective, the one or more constraints, and/or the algorithmic formulation of the optimization problem. The embedding vector may encode rich semantic content associated with to optimization problem such that it can be compared to information in the vector database to identify similar optimization problems that are associated in the vector database with particular types of optimization problem solvers. By identifying such similar optimization problems and the corresponding solvers, the system can leverage the optimal solver for a given optimization problem.

At block 314, the system may execute the query upon a vector database 316 to identify an optimization problem solver that is suited for the given optimization problem to be solved (e.g., using the RAG data processing module 105 of FIG. 1). The vector database 316 may include any of the aspects described above with reference to FIG. 2. The vector database may store, in association with indications of different optimization problem solvers (e.g., solver description 334 and/or solver category 336), information associated with optimization problems that can be solved using the respective solvers. The vector database may include embedding representations of optimization problem solvers and example optimization problems suitable for respective solvers. The vector database 316 may also include mathematical context 318 and business description/context 320. The context 330 (e.g., including the mathematical context 318 and business description/context 320 may include a description of an optimization problem. The context 330 can be used to identify and retrieve the most relevant examples 334 (e.g., example code) for incorporation into a prompt for the LLM agents. The vector database may enable the system to identify one or more embeddings within the vector database that are similar to an embedding representing the query, for instance, based on cosine similarity, Euclidean distance, etc. The system may compare information associated with the optimization problem described by a user input to information associated with optimization problem solvers stored in the vector database to identify an optimal solver for the given problem at hand. The optimal solver may be associated with the closest embedding to the query embedding. The system may select the identified solver to use for solving the optimization problem.

In some examples, the system may perform retrieval-augmented generation at block 314 to generate a prompt for the one or more LLM agents using information associated with the selected optimization problem solver retrieved using the vector database. For instance, the system may generate a prompt that includes example computer executable code, example programming modules (e.g., libraries), example business context, and/or example mathematical context associated, etc., to help guide the one or more LLM agents to generate computer executable code optimized for the selected optimization problem solver. The prompt may additionally include information from an output of one or more other LLM agents used by the system in method 300. For instance, the computer executable code may be generated based on the algorithmic representation of the optimization problem (e.g., the algorithmic representation of the constraints and/or optimization objective) that was generated using one or more other LLM agents (e.g., at block 310).

At block 322, the exemplary system may generate computer executable code specifying one or more characteristics of the optimization problem. The computer executable code may be generated using one or more LLM agents based on the selected optimization problem solver from block 314 using the prompt generated using retrieval-augmented generation.

At block 324, the system may execute the computer executable code to solve the optimization problem using the selected optimization problem solver. As discussed with reference to system 100, the solver may utilize one or more local computing resources and/or one or more cloud computing resources. In some examples, the selected solver may be accessible via an API. In some examples, the solver may be accessible via a memory of a computing device that received the input at block 402. In some examples, the exemplary system may establish a network connection with the selected optimization problem solver. The exemplary system may transmit the computer executable code to the selected optimization problem solver over the established network connection. The solver may execute the code and transmit a solution to the optimization problem back to the system. The exemplary system may receive the solution to the optimization problem from the optimization problem solver via the established network connection, and the exemplary system may output a solution to the optimization problem.

At block 326, the exemplary system may output the solution. The system may display the solution (e.g., via a GUI). The system may automatically provision a computational resource based on the solution to the optimization problem, automatically establish a network connection based on the solution to the optimization problem, and/or automatically send a control signal to an electromechanical device based on the solution to the optimization problem. The system may automatically configure a computing system to maximize or minimize a value using the solution to the optimization problem. In some examples, the value includes any one or more of: monetary cost, energy, material, time, distance, and computing resources.

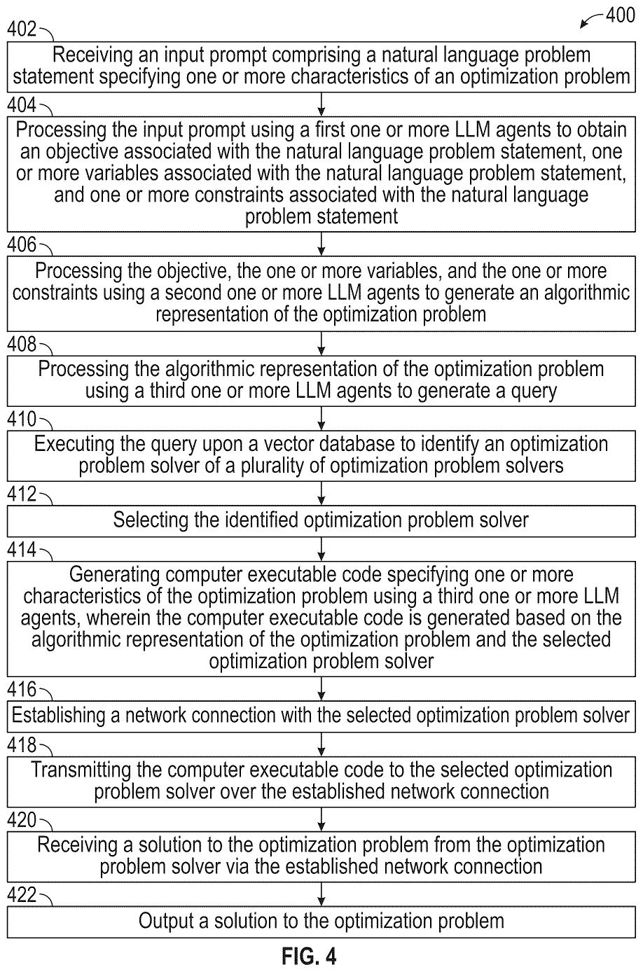

FIG. 4 illustrates an exemplary method 400 for solving an optimization problem using one or more LLM agents. Method 400 may be performed using any or all of the aspects described above with reference to FIGS. 1-3. Method 400 is performed, for example, using one or more electronic devices implementing a software platform. In some examples, method 400 is performed using a client-server system, and the steps of process 400 are divided up in any manner between the server and one or more client devices. In other examples, method 400 is performed using only a client device or only multiple client devices. In method 400, some steps are, optionally, combined, the order of some steps is, optionally, changed, and some steps are, optionally, omitted. In some examples, additional steps may be performed in combination with the method 400. Accordingly, the operations as illustrated (and described in greater detail below) are exemplary by nature and, as such, should not be viewed as limiting.

At block 402, an exemplary system (e.g., one or more electronic devices) may receive an input prompt specifying one or more characteristics of the optimization problem. The input may include a natural language problem statement specifying one or more characteristics of the optimization problem. The input may also include a dataset associated with the optimization problem. The input may be received via an interactive user interface. The input may include audio data or other media data. The dataset associated with the optimization problem may include structured data, etc. (e.g., images, video, . csv files, etc.). The dataset may include, for instance, variable symbols, parameter symbols, etc., which may enable the system to more accurately transform the input into computer executable code for solving the optimization problem. The input may include a request that a certain value be minimize or maximized (e.g., “find the shortest route”). The input may specify one or more characteristics of an optimization problem that can be solved using a quantum annealer or classical annealer.

At block 404, the exemplary system may process the input prompt using one or more LLM agents to obtain one or more objectives (e.g., optimization objectives) associated with the natural language problem statement, one or more variables associated with the natural language problem statement, and one or more constraints associated with the natural language problem statement. Processing the input prompt using the one or more LLM agents may include extracting a plurality of parameters from the input prompt and assigning a corresponding symbol to each of the plurality of parameters. Processing the input prompt using the one or more LLM agents may include replacing each of the plurality of parameters in the input prompt with the corresponding symbol. Processing the input prompt using the one or more LLM agents may include determining the optimization objective and/or one more variables (e.g., decision variables) based at least in part on the input prompt and the plurality of parameters.

In some examples, the exemplary system may process the input prompt using a first set of one or more LLM agents to obtain the objective (e.g., optimization objective) associated with the natural language problem statement, the one or more variables associated with the natural language problem statement, and the one or more constraints associated with the natural language problem statement. For instance, in some examples, a first LLM agent (e.g., a parameter extraction LLM agent) extracts a plurality of parameters from the prompt and assigns a corresponding symbol to each of the plurality of parameters. A second LLM agent (e.g., a problem formatter LLM agent) replaces each of the plurality of parameters in the prompt with the corresponding symbol to generate a revised prompt. A third LLM agent (e.g., an objective and variable extraction LLM agent) may determine an optimization objective based at least in part on the prompt and the plurality of parameters; and determine one or more decision variables based at least in part on the prompt and the plurality of parameters.

At block 406, the exemplary system may process the objective, the one or more variables, and the one or more constraints using one or more LLM agents to generate an algorithmic representation of the optimization problem. The system may generate an algorithmic representation of the one or more constraints and/or the optimization objective. In some examples a second set of one or more LLM agents is used by the system to generate the algorithmic representation of the optimization problem. For instance, a first LLM agent of the second set (e.g., an objective formulator LLM agent) may generate an algorithmic representation of the optimization objective and a second LLM agent of the second set (e.g., a constraints formulator LLM agent) may generate an algorithmic representation of the one or more constraints. The algorithmic representation of the one or more constraints and/or the optimization objective can be used by the system (e.g., by one or more LLM agents) to generate code for solving the optimization problem, as described below.

At block 408, the exemplary system may process the algorithmic representation of the optimization problem using one or more LLM agents to generate a query. Generating the query may include generating one or more embeddings. The embeddings may be generated using an embedding model (e.g., a machine learning model) trained to capture rich semantic information about the input prompt within a lower-dimensional embedding vector. The embeddings may include a lower dimensional representation of the algorithmic formulation of the optimization problem, the objective, the one or more constraints, and/or the one or more variables.

At block 410, the exemplary system may execute the query upon a vector database to identify an optimization problem solver of a plurality of optimization problem solvers. The system may compare the one or more generated embeddings that represent characteristics of the optimization problem described in the input to one or more embeddings stored in the vector database (e.g., as described with reference to FIGS. 1-3 above). The one or more embeddings stored in the vector database may represent characteristics of one or more example optimization problems and/or optimization problem solvers that can be used to solve the one or more example optimization problems. For instance, the one or more embeddings stored in the vector database may be generated using an industry indicator, an application type indicator, one or more optimization technique indicators, an objective function indicator, and/or an algorithmic formulation indicator associated with one or more optimization problems and an optimization problem solver that can be used to solve the one or more optimization problems. The system may identify one or more embeddings in the vector database based on a similarity (e.g., cosine similarity, Euclidean distance, semantic similarity) between characteristics of the one or more example optimization problems and the one or more embeddings representing the input received at block 402.

At block 412, the exemplary system may select the identified optimization problem solver. The system may provide an indication of the selected optimization problem solver to one or more LLM agents configured to generate computer executable code for solving the optimization problem described in the input. For instance, the system may generate (e.g., using a large language model) a natural language indication of the selected optimization problem solver and provide the indication of the selected optimization problem solver to the one or more LLM agents. The natural language indication may include examples of computer executable code for similar optimization problems associated with the selected solver (e.g., that were used to solve optimization problems by inputting the code into the selected solver) retrieved from the vector database. The examples of computer executable code used for similar optimization problems with the selected solver may be retrieved from the vector database such that the one or more LLM agents can be prompted to generate computer executable code via few-shot prompting.

In some examples, the system may retrieve additional information along with the example computer executable code to prompt the one or more LLM agents. For instance, the system may retrieve computer executable code associated with an example optimization problem, programming modules (e.g., libraries), business context associated with the example optimization problem, mathematical context associated with the example optimization problem (e.g., one or more mathematical/algorithmic representations of the optimization problem). In some examples, the system may retrieve synthetic data that was generated using a generative AI model (e.g., LLM), such as synthetic business context, synthetic computer executable code, synthetic mathematical context, and synthetic programming modules (e.g., libraries) may be generated using a generative AI model, such as a large language model (LLM). In some examples, the system may dynamically generate synthetic data using a generative AI model (e.g., LLM) that can be incorporated into a prompt for one or more LLM agents, e.g., using hypothetical document embedding (HyDE) methods.

At block 414, the exemplary system may generate computer executable code specifying one or more characteristics of the optimization problem using the one or more LLM agents. The system may generate a prompt for the one or more LLM agents using information associated with the selected optimization problem solver retrieved from the vector database to guide the LLM agents in generating the computer executable code. For instance, the system may generate a prompt that includes example computer executable code, example programming modules (e.g., libraries), example business context, and/or example mathematical context associated, etc., to help guide the one or more LLM agents to generate computer executable code optimized for the selected optimization problem solver. The prompt may additionally include information from an output of one or more other LLM agents used by the system in method 400. For instance, the computer executable code may be generated using the algorithmic representation of the optimization problem (e.g., the algorithmic representation of the constraints and/or optimization objective) generated using one or more other LLM agents.

At block 416, the exemplary system may establish a network connection with the selected optimization problem solver. At block 418, the exemplary system may transmit the computer executable code to the selected optimization problem solver over the established network connection. At block 420, the exemplary system may receive a solution to the optimization problem from the optimization problem solver via the established network connection. At block 422, the exemplary system may output a solution to the optimization problem. It should be understood that the solver may instead be run using the same computing system or computing device as the plurality of LLM agents, and in such cases a network connection may not be needed to input the computer executable code into the solver.

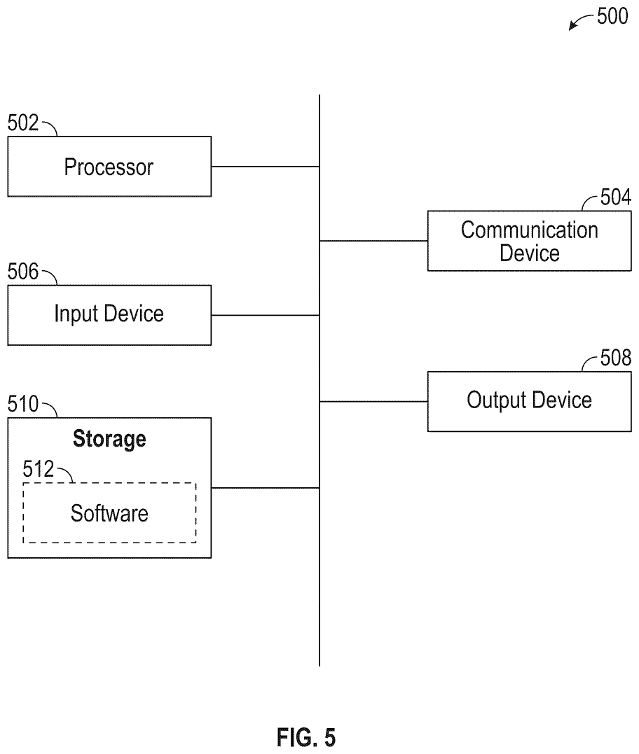

FIG. 5 depicts an exemplary computing device 500, which may be used in accordance with one or more examples of the disclosure. Device 500 can be a host computer connected to a network. Device 500 can be a client computer or a server. As shown in FIG. 5, device 500 can be any suitable type of microprocessor-based device, such as a personal computer, workstation, server, or handheld computing device (portable electronic device) such as a phone or tablet. The device can include, for example, one or more of processors 502, input device 506, output device 508, storage 510, and communication device 504. Input device 506 and output device 508 can generally correspond to those described above and can either be connectable or integrated with the computer.

Input device 506 can be any suitable device that provides input, such as a touch screen, keyboard or keypad, mouse, or voice-recognition device. Output device 508 can be any suitable device that provides output, such as a touch screen, haptics device, or speaker.

Storage 510 can be any suitable device that provides storage, such as an electrical, magnetic, or optical memory, including a RAM, cache, hard drive, or removable storage disk. Communication device 504 can include any suitable device capable of transmitting and receiving signals over a network, such as a network interface chip or device. The components of the computer can be connected in any suitable manner, such as via a physical bus or wirelessly.

Software 512, which can be stored in storage 510 and executed by processor 502, can include, for example, the programming that embodies the functionality of the present disclosure (e.g., as embodied in the devices as described above).

Software 512 can also be stored and/or transported within any non-transitory computer-readable storage medium for use by or in connection with an instruction execution system, apparatus, or device, such as those described above, that can fetch instructions associated with the software from the instruction execution system, apparatus, or device and execute the instructions. In the context of this disclosure, a computer-readable storage medium can be any medium, such as storage 510, that can contain or store programming for use by or in connection with an instruction execution system, apparatus, or device.

Software 512 can also be propagated within any transport medium for use by or in connection with an instruction execution system, apparatus, or device, such as those described above, that can fetch instructions associated with the software from the instruction execution system, apparatus, or device and execute the instructions. In the context of this disclosure, a transport medium can be any medium that can communicate, propagate, or transport programming for use by or in connection with an instruction execution system, apparatus, or device. The transport readable medium can include, but is not limited to, an electronic, magnetic, optical, electromagnetic, or infrared wired or wireless propagation medium.

Device 500 may be connected to a network, which can be any suitable type of interconnected communication system. The network can implement any suitable communications protocol and can be secured by any suitable security protocol. The network can comprise network links of any suitable arrangement that can implement the transmission and reception of network signals, such as wireless network connections, T1 or T3 lines, cable networks, DSL, or telephone lines.

Device 500 can implement any operating system suitable for operating on the network. Software 512 can be written in any suitable programming language, such as C, C++, Java, or Python. In various embodiments, application software embodying the functionality of the present disclosure can be deployed in different configurations, such as in a client/server arrangement or through a Web browser as a Web-based application or Web service, for example.

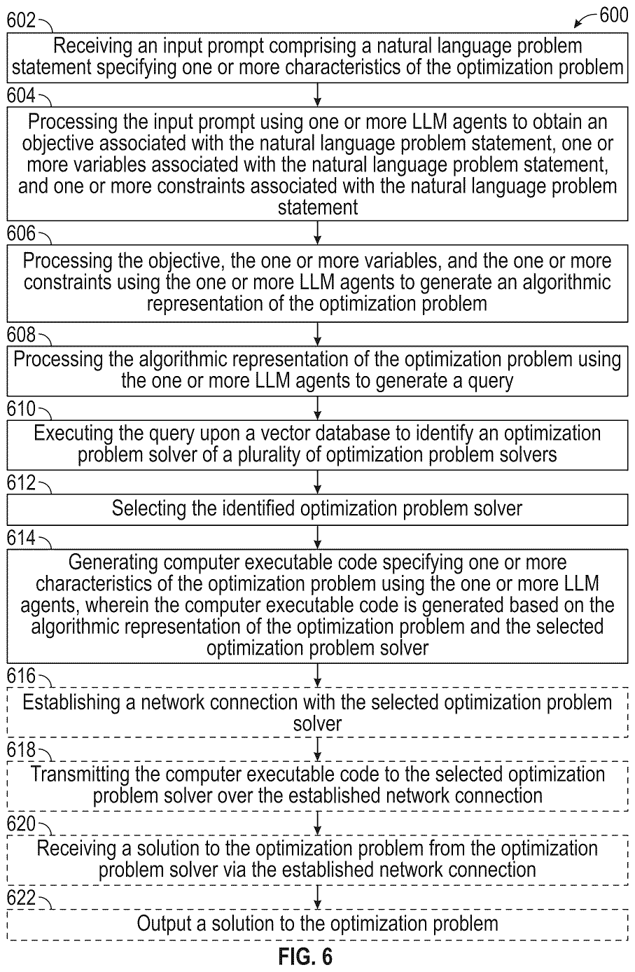

FIG. 6 illustrates an exemplary method 600 for solving optimization problems using one or more LLM agents. Method 600 may be performed using any or all of the aspects described above with reference to FIGS. 1-5. Method 600 may include automatically selecting an optimal optimization problem solver for a respective problem and prompting one or more LLM agents with examples associated with the selected solver to teach the one or more LLM agents how to interact with (e.g., generate code for) the selected solver. In some examples, method 600 is performed using a single LLM agent or multiple LLM agents. In some examples, method 600 may be performed using a plurality of LLM agents operating in series with one another. In some examples, method 600 may be performed using a plurality of LLM agents where some LLM agents operate in series with one another and others operate in parallel with one another.

Method 600 is performed, for example, using one or more electronic devices implementing a software platform. In some examples, method 600 is performed using a client-server system, and the steps of process 600 are divided up in any manner between the server and one or more client devices. In other examples, method 600 is performed using only a client device or only multiple client devices. In method 600, some steps are, optionally, combined, the order of some steps is, optionally, changed, and some steps are, optionally, omitted. In some examples, additional steps may be performed in combination with the method 600. Accordingly, the operations as illustrated (and described in greater detail below) are exemplary by nature and, as such, should not be viewed as limiting.

At block 602, an exemplary system may receive an input prompt comprising a natural language problem statement specifying one or more characteristics of an optimization problem. At block 604, the exemplary system may process the input prompt using one or more LLM agents to obtain data associated with the input prompt. In some examples the data associated with the input prompt includes an objective associated with the natural language problem statement, one or more variables associated with the natural language problem statement, and one or more constraints associated with the natural language problem statement.

At block 606, the exemplary system may process the data associated with the input prompt to generate an algorithmic representation of the optimization problem. The system may process the objective, the one or more variables, and the one or more constraints using the one or more LLM agents to generate an algorithmic representation of the optimization problem. At block 608, the exemplary system may process the algorithmic representation of the optimization problem using the one or more LLM agents to generate a query. Generating the query may include generating one or more embeddings (e.g., as described throughout). The one or more embeddings may comprise a lower dimensional representation of the algorithmic formulation of the optimization problem, the objective, the one or more constraints, and/or the one or more variables.

At block 610, the exemplary system may execute the query upon a vector database to identify an optimization problem solver of a plurality of optimization problem solvers. Executing the query upon the vector database may include comparing the one or more embeddings to one or more embeddings representing one or more of the plurality of optimization problem solvers. The plurality of optimization problem solvers may be associated in the vector database with an industry indicator, an application type indicator, one or more optimization technique indicators, an objective function indicator, and/or an algorithmic formulation indicator. For instance, one or more embeddings representing the industry indicator, application type indicator, one or more optimization technique indicators, objective function indicator, and/or algorithmic formulation indicator may be stored in association with the optimization problem solver in the vector database. The one or more optimization problem solvers may be associated in the vector database with context data generated using a large language model. The context data may include one or more business problems similar to the example optimization problem associated with the optimization problem solver, one or more computer executable code examples, one or more executable code modules, and synthetic data. The plurality of optimization problem solvers may include any one or more of: a linear programming solver, mixed integer linear programming solver, convex optimization problem solver, non-convex optimization problem solver, constrained optimization problem solver, stochastic optimization problem solver, discrete optimization problem solver, continuous optimization problem solver, and non-linear optimization problem solver.

At block 612, the exemplary system may select the identified optimization problem solver. The system may generate synthetic data associated with the selected optimization problem solve using the large language model and may provide the synthetic data to the one or more LLM agents. In some examples, the system may retrieve data associated with the selected optimization problem solver from a location identified by the vector database and generate a prompt for the one or more LLM agents comprising the retrieved data. In some examples, the system may retrieve the data from the vector database. In some examples, the retrieved data includes example code associated with the selected optimization problem solver. In some examples, generating the prompt comprises incorporating the example code associated with the selected optimization problem solver into the prompt. In some examples, some aspects of the generated prompt for the one or more LLM agents may be hard-coded/predefined while other aspects (e.g., the retrieved information) may be dynamically configured (e.g., by incorporating retrieved data into the prompt). In some examples, the retrieved data may be incorporated into the prompt using one or more predefined rules. In some examples, the system may generate, using a large language model, a natural language response indicating the selected optimization problem solver; and provide the indication of the selected optimization problem solver to the one or more LLM agents.

At block 614, the exemplary system may generate computer executable code specifying one or more characteristics of the optimization problem using the one or more LLM agents. The computer executable code may be generated based on the algorithmic representation of the optimization problem and the selected optimization problem solver. In some examples, the code may be generated by the one or more LLM agents based on the prompt that includes the example code associated with the selected optimization problem solver.

At block 616, the exemplary system may establish a network connection with the selected optimization problem solver. At block 618, the exemplary system may transmit the computer executable code to the selected optimization problem solver over the established network connection. At block 620, the exemplary system may receive a solution to the optimization problem from the optimization problem solver via the established network connection. At block 622, the exemplary system may output a solution to the optimization problem. In some examples, the system may store data associated with the solution to the optimization problem in the vector database. Storing data associated with the solution to the optimization problem in the vector database may include: generating one or more embeddings associated with the selected optimization problem solver; and storing the one or more embeddings in the vector database. Outputting a solution to the optimization problem using the one or more LLM agents may include generating a natural language report describing the solution.

In some examples, method 600 includes configuring a computing system to maximize or minimize a value using the solution to the optimization problem, wherein the value comprises any one or more of: monetary cost, energy, material, time, distance, and computing resources. In some examples, method 600 includes automatically provisioning a computational resource based on the solution to the optimization problem, automatically establishing a network connection based on the solution to the optimization problem, sending a control signal to an electromechanical device based on the solution to the optimization problem, and/or comprising displaying the solution to the optimization problem.

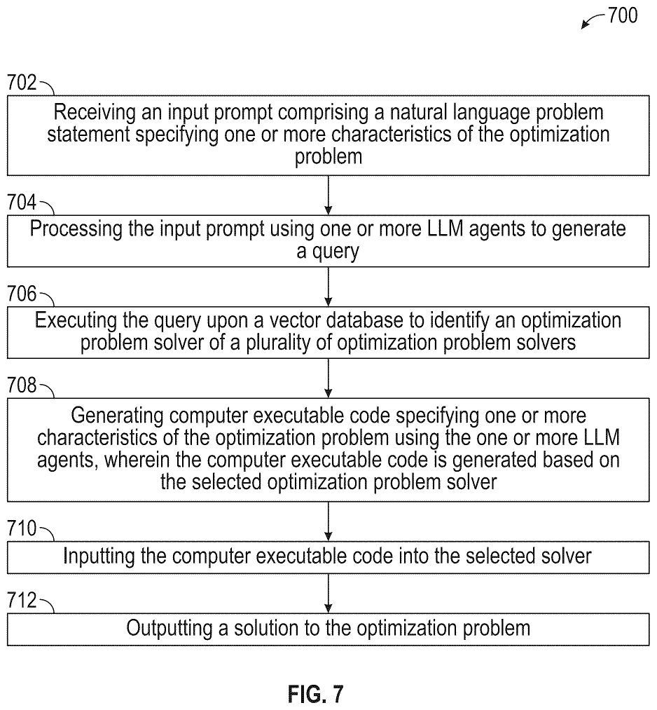

FIG. 7 illustrates an exemplary method 700 for solving an optimization problem using one or more LLM agents. Method 700 may be performed using any or all of the aspects described above with reference to FIGS. 1-6. For instance, aspects of method 700 may be performed using aspects of system 100 and/or computing device 500. In some examples, steps from methods 200, 300, 400, and/or 600 may be included in method 700. Method 700 may include automatically selecting an optimal optimization problem solver for a respective problem and prompting one or more LLM agents with examples associated with the selected solver to teach the one or more LLM agents how to interact with (e.g., generate code for) the selected solver. In some examples, method 700 is performed using a single LLM agent or multiple LLM agents. In some examples, method 700 may be performed using a plurality of LLM agents operating in series with one another. In some examples, method 700 may be performed using a plurality of LLM agents where some LLM agents operate in series with one another and others operate in parallel with one another.

Method 700 is performed, for example, using one or more electronic devices implementing a software platform. In some examples, method 700 is performed using a client-server system, and the steps of process 700 are divided up in any manner between the server and one or more client devices. In other examples, method 700 is performed using only a client device or only multiple client devices. In method 700, some steps are, optionally, combined, the order of some steps is, optionally, changed, and some steps are, optionally, omitted. In some examples, additional steps may be performed in combination with the method 700. Accordingly, the operations as illustrated (and described in greater detail below) are exemplary by nature and, as such, should not be viewed as limiting.

At block 702, an exemplary system may receive an input prompt comprising a natural language problem statement specifying one or more characteristics of the optimization problem. At block 704, the system may process the input prompt using one or more LLM agents to generate a query. The query may be encoded into an embedding (e.g., using an embedding model, as described throughout). At block 706, the system may execute the query upon a vector database to identify an optimization problem solver of a plurality of optimization problem solvers (e.g., based on a similarity between the embedding generated based on the query and one or more embeddings in the vector database). At block 708, the system may generate computer executable code specifying one or more characteristics of the optimization problem using the one or more LLM agents. The computer executable code may be generated based on the identified optimization problem solver. The system may prompt the one or more LLM agents to generate the code using data/examples associated with the identified solver retrieved from the vector database (or from a location indicated by the vector database). At block 710, the system may input the computer executable code into the identified solver. At block 712, the system may output a solution to the optimization problem. In some examples, method 700 includes configuring a computing system to maximize or minimize a value using the solution to the optimization problem, wherein the value comprises any one or more of: monetary cost, energy, material, time, distance, and computing resources. In some examples, method 700 includes automatically provisioning a computational resource based on the solution to the optimization problem, automatically establishing a network connection based on the solution to the optimization problem, sending a control signal to an electromechanical device based on the solution to the optimization problem, and/or comprising displaying the solution to the optimization problem.

Appendix A includes exemplary descriptions of various aspects of optimization techniques according to one or more examples disclosed herein. Any or all of the information included in Appendix A may be used to create embedding vector representations representing characteristics of different optimization problem solvers and the optimization problems that those solvers are suited for solving. Any or all of the information included in Appendix A may be included in one or more json files that are respectively encoded into the one or more embeddings. Table 1 of Appendix A provides an overview of optimization techniques, a description of example use cases for respective optimization techniques, optimization methods, approach descriptions, tools (which may include solver types), business domains, and application examples associated with those business domains, that may be encoded into embedding vectors representing one or more optimization problem solvers, as described throughout. Table 2 provides an overview of some industries where optimization is used to solve problems, particular example applications associated with each industry, and optimization techniques associated with each application. Table 3 provides an overview of optimization techniques, example applications, objective functions, constraints, tools (which may include solver types), industrial domains, and mathematical/algorithmic formulations associated with different optimization problems, that may be encoded into embedding vectors representing one or more optimization problem solvers, as described throughout.

As discussed above, any or all of the information included in Table 1 through Table 3 of Appendix A may be encoded into one or more embedding vectors that represent characteristics of different optimization problem and the types of optimization problems those solvers are suited for. The embedding vectors generated using the information in Appendix A may be stored in a vector database and used according to the systems and methods disclosed herein to identify the appropriate optimization problem solver for a problem statement that specifies characteristics of an optimization problem (e.g., received from a user).

As an example, a problem statement that specifies one or more characteristics of an optimization problem may be received by an exemplary system. The exemplary system may process the input to determine characteristics associated with the optimization problem. The system may determine one or more objectives associated with the natural language problem statement, one or more variables associated with the natural language problem statement, and/or one or more constraints associated with the natural language problem statement using one or more LLM agents. The system may process the one or more objectives, the one or more variables, and the one or more constraints using the one or more LLM agents to generate an algorithmic representation of the optimization problem. The system may generate a query using the characteristics associated with the optimization problem. For instance, the system may generate a query using the one or more objectives, the one or more variables, the one or more constraints, and/or the algorithmic representation of the optimization problem. The system may generate an embedding representation of the query (e.g., using an embedding model). The system may then execute the query upon a vector database to identify an optimization problem solver of a plurality of optimization problem solvers.

In some examples, the one or more characteristics associated with the optimization problem specified in the user input may indicate that the optimization problem is related to healthcare. For instance, the one or more characteristics may indicate that the optimization problem specified in the user input is related to any of medical staff scheduling, patient flow optimization, medical treatment (e.g., radiotherapy treatment), operating room scheduling, drug formulation optimization, etc. In an example in which the one or more characteristics indicate that the optimization problem specified in the user input is related to drug formulation optimization, the system may identify one or more embeddings in the vector database associated with drug formulation optimization that are similar to the embedding generated based on the user input. The one or more embeddings in the vector database associated with drug formulation optimization may include (or point to) indications of optimization techniques, such as genetic algorithms or gradient descent, that can be used to solve optimization problems for drug formulation optimization, tools (e.g., MATLAB, Pyomo, Aspen, etc.) that can be used to solve such problems, objective function examples (e.g., “maximize efficacy of drug formula”), constraints examples, mathematical/algorithmic formulation examples, etc., that may be used to prompt one or more LLM agents to generate code to solve the optimization problem specified in the user input. The system may select the appropriate solver, e.g., based on the most similar embedding in the vector database, and generate a prompt for the one or more LLM agents using information retrieved from the vector database and/or a location indicated by the vector database.

In some examples, the one or more characteristics associated with the optimization problem specified in the user input may indicate that the optimization problem is related to telecommunications. For instance, the one or more characteristics may indicate that the optimization problem specified in the user input is related to any of network design optimization, spectrum allocation, traffic routing in networks, tower placement optimization, 5G network slicing, etc. In an example in which the one or more characteristics indicate that the optimization problem specified in the user input is related to spectrum allocation, the system may identify one or more embeddings in the vector database associated with spectrum allocation that are similar to the embedding generated based on the user input. The one or more embeddings in the vector database associated with spectrum allocation may include (or point to) indications of optimization techniques, such as game theory or linear programming, that can be used to solve optimization problems related to spectrum allocation, one or more tools (e.g., MATLAB, OptiNet, Python), that can be used to solve such problems, objective function examples (e.g., “Maximize spectrum utilization”), constraints examples (e.g., interference limits, user demand), and/or mathematical/algorithmic formulation examples for such problems, etc., that may be used to prompt one or more LLM agents to generate code to solve the optimization problem specified in the user input. The system may select the appropriate solver, e.g., based on the most similar embedding in the vector database, and generate a prompt for the one or more LLM agents using information retrieved from the vector database and/or a location indicated by the vector database.

While the examples described above refer to healthcare and telecommunications optimization problems, it should be understood that any or all of the information included in Appendix A and/or other information associated with respective solvers and example optimization problems may be included in the vector database. The systems disclosed herein can utilize this information to prompt LLM agents and select the appropriate solver for any variety of optimization problems. The systems disclosed herein can be used to solve optimization problems in numerous industries, including, for instance, manufacturing, logistics & transportation, finance, energy, telecommunications, retail, healthcare, aerospace, automotive, agriculture, pharmaceuticals, mining, shipping, etc.

Although the disclosure and examples have been fully described with reference to the accompanying figures, it is to be noted that various changes and modifications will become apparent to those skilled in the art. Such changes and modifications are to be understood as being included within the scope of the disclosure and examples as defined by the claims. Finally, the entire disclosure of the patents and publications referred to in this application are hereby incorporated herein by reference.

### Exemplary Embodiments

1. A method for solving an optimization problem using one or more LLM agents, the method comprising:
   receiving an input prompt comprising a natural language problem statement specifying one or more characteristics of the optimization problem;
   processing the input prompt using one or more LLM agents to obtain an objective associated with the natural language problem statement, one or more variables associated with the natural language problem statement, and one or more constraints associated with the natural language problem statement;
   processing the objective, the one or more variables, and the one or more constraints using the one or more LLM agents to generate an algorithmic representation of the optimization problem;
   processing the algorithmic representation of the optimization problem using the one or more LLM agents to generate a query;
   executing the query upon a vector database to identify an optimization problem solver of a plurality of optimization problem solvers;
   selecting the identified optimization problem solver;
   generating computer executable code specifying one or more characteristics of the optimization problem using the one or more LLM agents, wherein the computer executable code is generated based on the algorithmic representation of the optimization problem and the selected optimization problem solver;
   establishing a network connection with the selected optimization problem solver;
   transmitting the computer executable code to the selected optimization problem solver over the established network connection;
   receiving a solution to the optimization problem from the optimization problem solver via the established network connection; and
   outputting a solution to the optimization problem.
2. The method of embodiment 1, wherein generating the query comprises generating one or more embeddings.
3. The method of embodiment 2, wherein the one or more embeddings comprise a lower dimensional representation of the algorithmic formulation of the optimization problem, the objective, the one or more constraints, and the one or more variables.
4. The method of any one of embodiments 2-3, wherein executing the query upon the vector database comprises comparing the one or more embeddings to one or more embeddings representing one or more of the plurality of optimization problem solvers.
5. The method of embodiment 4, comprising:
   generating, using a large language model, a natural language response indicating the selected optimization problem solver; and
   providing the indication of the selected optimization problem solver to the one or more LLM agents.
6. The method of embodiment 5, comprising: generating synthetic data associated with the selected optimization problem solver using the large language model; and providing the synthetic data to the one or more LLM agents.
7. The method of any one of embodiments 1-6, wherein the plurality of optimization problem solvers are associated in the vector database with:
   an industry indicator, an application type indicator, one or more optimization technique indicators, an objective function indicator, and an algorithmic formulation indicator.
8. The method of embodiment 7, wherein the one or more optimization problem solvers are associated in the vector database with context data generated using a large language model.
9. The method of embodiment 8, wherein the context data comprises:
   one or more business problems similar to the example optimization problem associated with the optimization problem solver, one or more computer executable code examples, one or more executable code modules, and synthetic data.
10. The method of any one of embodiments 1-9, comprising:
   retrieving data associated with the selected optimization problem solver from the vector database; and
   generating a prompt for the one or more LLM agents comprising the retrieved data.
11. The method of embodiment 10, wherein the retrieved data comprises example code associated with the selected optimization problem solver.
12. The method of embodiment 11, wherein generating the prompt comprises incorporating the example code associated with the selected optimization problem solver into the prompt.
13. The method of any one of embodiments 1-12, comprising: storing data associated with the solution to the optimization problem in the vector database.
14. The method of embodiment 13, wherein storing data associated with the solution to the optimization problem in the vector database comprises:
   generating one or more embeddings associated with the selected optimization problem solver; and
   storing the one or more embeddings in the vector database.
15. The method of any one of embodiments 1-14, wherein the plurality of optimization problem solvers comprise any one or more of: a linear programming solver, mixed integer linear programming solver, convex optimization problem solver, non-convex optimization problem solver, constrained optimization problem solver, stochastic optimization problem solver, discrete optimization problem solver, continuous optimization problem solver, and non-linear optimization problem solver.
16. The method of any one of embodiments 1-15, wherein outputting a solution to the optimization problem using the one or more LLM agents comprises generating a natural language report describing the solution.
17. The method of any one of embodiments 1-16, comprising: configuring a computing system to maximize or minimize a value using the solution to the optimization problem, wherein the value comprises any one or more of: monetary cost, energy, material, time, distance, and computing resources.
18. The method of any one of embodiments 1-17, comprising: automatically provisioning a computational resource based on the solution to the optimization problem.
19. The method of any one of embodiments 1-18, comprising: automatically establishing a network connection based on the solution to the optimization problem.
20. The method of any one of embodiments 1-19, comprising: sending a control signal to an electromechanical device based on the solution to the optimization problem.
21. The method of any one of embodiments 1-20, comprising: comprising displaying the solution to the optimization problem.
22. A system for solving an optimization problem using one or more LLM agents, the system comprising: one or more processors, a memory, and one or more programs, wherein the one or more programs are stored in the memory and configured to be executed by the one or more processors, the one or more programs including instructions for:
   receiving an input prompt comprising a natural language problem statement specifying one or more characteristics of the optimization problem;
   processing the input prompt using one or more LLM agents to obtain an objective associated with the natural language problem statement, one or more variables associated with the natural language problem statement, and one or more constraints associated with the natural language problem statement;
   processing the objective, the one or more variables, and the one or more constraints using the one or more LLM agents to generate an algorithmic representation of the optimization problem;
   processing the algorithmic representation of the optimization problem using the one or more LLM agents to generate a query;
   executing the query upon a vector database to identify an optimization problem solver of a plurality of optimization problem solvers;
   selecting the identified optimization problem solver;
   generating computer executable code specifying one or more characteristics of the optimization problem using the one or more LLM agents, wherein the computer executable code is generated based on the algorithmic representation of the optimization problem and the selected optimization problem solver;
   establishing a network connection with the selected optimization problem solver;
   transmitting the computer executable code to the selected optimization problem solver over the established network connection;
   receiving a solution to the optimization problem from the optimization problem solver via the established network connection; and
   outputting a solution to the optimization problem.
23. A non-transitory computer-readable storage medium storing one or more programs for solving an optimization problem using one or more LLM agents, the one or more programs comprising instructions, which when executed by one or more processors of an electronic device, cause the electronic device to:
   receive an input prompt comprising a natural language problem statement specifying one or more characteristics of the optimization problem;
   process the input prompt using one or more LLM agents to obtain an objective associated with the natural language problem statement, one or more variables associated with the natural language problem statement, and one or more constraints associated with the natural language problem statement;
   process the objective, the one or more variables, and the one or more constraints using the one or more LLM agents to generate an algorithmic representation of the optimization problem;
   process the algorithmic representation of the optimization problem using the one or more LLM agents to generate a query;
   execute the query upon a vector database to identify an optimization problem solver of a plurality of optimization problem solvers;
   select the identified optimization problem solver;
   generate computer executable code specifying one or more characteristics of the optimization problem using the one or more LLM agents, wherein the computer executable code is generated based on the algorithmic representation of the optimization problem and the selected optimization problem solver;
   establish a network connection with the selected optimization problem solver;
   transmit the computer executable code to the selected optimization problem solver over the established network connection;
   receive a solution to the optimization problem from the optimization problem solver via the established network connection; and
   output a solution to the optimization problem.
24. A method for solving an optimization problem using one or more LLM agents, the method comprising:
   receiving an input prompt comprising a natural language problem statement specifying one or more characteristics of the optimization problem;
   processing the input prompt using one or more LLM agents to generate a query;
   executing the query upon a vector database to identify an optimization problem solver of a plurality of optimization problem solvers;
   generating computer executable code specifying one or more characteristics of the optimization problem using the one or more LLM agents, wherein the computer executable code is generated based on the identified optimization problem solver;
   inputting the computer executable code into the identified optimization problem solver; and
   outputting a solution to the optimization problem.
25. The method of embodiment 24, wherein generating the query comprises generating one or more embeddings.
26. The method of embodiment 25, wherein the one or more embeddings comprise a lower dimensional representation of an algorithmic formulation of the optimization problem, an objective associated with the optimization problem, one or more constraints associated with the optimization problem, and one or more variables associated with the optimization problem.
27. The method of any one of embodiments 25-26, wherein executing the query upon the vector database comprises comparing the one or more embeddings to one or more embeddings representing one or more of the plurality of optimization problem solvers.
28. The method of embodiment 27, comprising:
   generating, using a large language model, a natural language response indicating the identified optimization problem solver; and
   providing the indication of the identified optimization problem solver to the one or more LLM agents.
29. The method of embodiment 28, comprising: generating synthetic data associated with the identified optimization problem solver using the large language model; and providing the synthetic data to the one or more LLM agents.
30. The method of any one of embodiments 24-29, wherein the plurality of optimization problem solvers are associated in the vector database with:
   an industry indicator, an application type indicator, one or more optimization technique indicators, an objective function indicator, and an algorithmic formulation indicator.
31. The method of embodiment 30, wherein the one or more optimization problem solvers are associated in the vector database with context data generated using a large language model.
32. The method of embodiment 31, wherein the context data comprises:
   one or more business problems similar to the example optimization problem associated with the optimization problem solver, one or more computer executable code examples, one or more executable code modules, and synthetic data.
33. The method of any one of embodiments 24-32, comprising:
   retrieving data associated with the identified optimization problem solver from the vector database; and
   generating a prompt for the one or more LLM agents comprising the retrieved data.
34. The method of embodiment 33, wherein the retrieved data comprises example code associated with the identified optimization problem solver.
35. The method of embodiment 34, wherein generating the prompt comprises incorporating the example code associated with the identified optimization problem solver into the prompt.
36. The method of any one of embodiments 24-35, comprising: storing data associated with the solution to the optimization problem in the vector database.
37. The method of embodiment 36, wherein storing data associated with the solution to the optimization problem in the vector database comprises:
   generating one or more embeddings associated with the identified optimization problem solver; and
   storing the one or more embeddings in the vector database.
38. The method of any one of embodiments 24-37, wherein the plurality of optimization problem solvers comprise any one or more of: a linear programming solver, mixed integer linear programming solver, convex optimization problem solver, non-convex optimization problem solver, constrained optimization problem solver, stochastic optimization problem solver, discrete optimization problem solver, continuous optimization problem solver, and non-linear optimization problem solver.
39. The method of any one of embodiments 24-38, wherein outputting a solution to the optimization problem using the one or more LLM agents comprises generating a natural language report describing the solution.
40. The method of any one of embodiments 24-39, comprising: configuring a computing system to maximize or minimize a value using the solution to the optimization problem, wherein the value comprises any one or more of: monetary cost, energy, material, time, distance, and computing resources.
41. The method of any one of embodiments 24-40, comprising: automatically provisioning a computational resource based on the solution to the optimization problem.
42. The method of any one of embodiments 24-41, comprising: automatically establishing a network connection based on the solution to the optimization problem.
43. The method of any one of embodiments 24-42, comprising: sending a control signal to an electromechanical device based on the solution to the optimization problem.
44. The method of any one of embodiments 24-43, comprising: comprising displaying the solution to the optimization problem.
45. A system for solving an optimization problem using one or more LLM agents, the system comprising: one or more processors, a memory, and one or more programs, wherein the one or more programs are stored in the memory and configured to be executed by the one or more processors, the one or more programs including instructions for:
   receiving an input prompt comprising a natural language problem statement specifying one or more characteristics of the optimization problem;
   processing the input prompt using one or more LLM agents to generate a query;
   executing the query upon a vector database to identify an optimization problem solver of a plurality of optimization problem solvers;
   generating computer executable code specifying one or more characteristics of the optimization problem using the one or more LLM agents, wherein the computer executable code is generated based on the identified optimization problem solver;
   inputting the computer executable code into the identified optimization problem solver; and
   outputting a solution to the optimization problem.
46. A non-transitory computer-readable storage medium storing one or more programs for solving an optimization problem using one or more LLM agents, the one or more programs comprising instructions, which when executed by one or more processors of an electronic device, cause the electronic device to:
   receive an input prompt comprising a natural language problem statement specifying one or more characteristics of the optimization problem;
   process the input prompt using one or more LLM agents to generate a query;
   execute the query upon a vector database to identify an optimization problem solver of a plurality of optimization problem solvers;
   generate computer executable code specifying one or more characteristics of the optimization problem using the one or more LLM agents, wherein the computer executable code is generated based on the identified optimization problem solver;
   input the computer executable code into the identified optimization problem solver; and
   output a solution to the optimization problem.

1. A method for solving an optimization problem using one or more LLM agents, the method comprising:
receiving an input prompt comprising a natural language problem statement specifying one or more characteristics of the optimization problem;
processing the input prompt using one or more LLM agents to generate a query;
executing the query upon a vector database to identify an optimization problem solver of a plurality of optimization problem solvers;
generating computer executable code specifying one or more characteristics of the optimization problem using the one or more LLM agents, wherein the computer executable code is generated based on the identified optimization problem solver;
inputting the computer executable code into the identified optimization problem solver; and
outputting a solution to the optimization problem.

2. The method of claim 1, wherein generating the query comprises generating one or more embeddings.

3. The method of claim 2, wherein the one or more embeddings comprise a lower dimensional representation of an algorithmic formulation of the optimization problem, an objective associated with the optimization problem, one or more constraints associated with the optimization problem, and one or more variables associated with the optimization problem.

4. The method of claim 2, wherein executing the query upon the vector database comprises comparing the one or more embeddings to one or more embeddings representing one or more of the plurality of optimization problem solvers.

5. The method of claim 4, comprising:
generating, using a large language model, a natural language response indicating the identified optimization problem solver; and
providing the indication of the identified optimization problem solver to the one or more LLM agents.

6. The method of claim 5, comprising: generating synthetic data associated with the identified optimization problem solver using the large language model; and providing the synthetic data to the one or more LLM agents.

7. The method of claim 1, wherein the plurality of optimization problem solvers are associated in the vector database with:
an industry indicator, an application type indicator, one or more optimization technique indicators, an objective function indicator, and an algorithmic formulation indicator.

8. The method of claim 1, wherein the plurality of optimization problem solvers are associated in the vector database with context data generated using a large language model.

9. The method of claim 8, wherein the context data comprises:
one or more business problems similar to the example optimization problem associated with the optimization problem solver, one or more computer executable code examples, one or more executable code modules, and synthetic data.

10. The method of claim 1, comprising:
retrieving data associated with the identified optimization problem solver from the vector database; and
generating a prompt for the one or more LLM agents comprising the retrieved data.

11. The method of claim 10, wherein the retrieved data comprises example code associated with the identified optimization problem solver.

12. The method of claim 11, wherein generating the prompt comprises incorporating the example code associated with the identified optimization problem solver into the prompt.

13. The method of claim 1, comprising: storing data associated with the solution to the optimization problem in the vector database.

14. The method of claim 13, wherein storing data associated with the solution to the optimization problem in the vector database comprises:
generating one or more embeddings associated with the identified optimization problem solver; and
storing the one or more embeddings in the vector database.

15. The method of claim 1, wherein the plurality of optimization problem solvers comprise any one or more of: a linear programming solver, mixed integer linear programming solver, convex optimization problem solver, non-convex optimization problem solver, constrained optimization problem solver, stochastic optimization problem solver, discrete optimization problem solver, continuous optimization problem solver, and non-linear optimization problem solver.

16. The method of claim 1, wherein outputting a solution to the optimization problem using the one or more LLM agents comprises generating a natural language report describing the solution.

17. The method of claim 1, comprising: configuring a computing system to maximize or minimize a value using the solution to the optimization problem, wherein the value comprises any one or more of: monetary cost, energy, material, time, distance, and computing resources.

18. The method of claim 1, comprising:
automatically provisioning a computational resource based on the solution to the optimization problem;
automatically establishing a network connection based on the solution to the optimization problem;
sending a control signal to an electromechanical device based on the solution to the optimization problem;
displaying the solution to the optimization problem; or
any combination thereof.

19. A system for solving an optimization problem using one or more LLM agents, the system comprising: one or more processors, a memory, and one or more programs, wherein the one or more programs are stored in the memory and configured to be executed by the one or more processors, the one or more programs including instructions for:
receiving an input prompt comprising a natural language problem statement specifying one or more characteristics of the optimization problem;
processing the input prompt using one or more LLM agents to generate a query;
executing the query upon a vector database to identify an optimization problem solver of a plurality of optimization problem solvers;
generating computer executable code specifying one or more characteristics of the optimization problem using the one or more LLM agents, wherein the computer executable code is generated based on the identified optimization problem solver;
inputting the computer executable code into the identified optimization problem solver; and
outputting a solution to the optimization problem.

20. A non-transitory computer-readable storage medium storing one or more programs for solving an optimization problem using one or more LLM agents, the one or more programs comprising instructions, which when executed by one or more processors of an electronic device, cause the electronic device to:
receive an input prompt comprising a natural language problem statement specifying one or more characteristics of the optimization problem;
process the input prompt using one or more LLM agents to generate a query;
execute the query upon a vector database to identify an optimization problem solver of a plurality of optimization problem solvers;
generate computer executable code specifying one or more characteristics of the optimization problem using the one or more LLM agents, wherein the computer executable code is generated based on the identified optimization problem solver;
input the computer executable code into the identified optimization problem solver; and
output a solution to the optimization problem.
